(19) United States
(12) Patent Application Publication
(10) Pub. No.: US 2018/0338549 A1
(43) Pub. Date: Nov. 29, 2018

(54) Body Covering

(71) Applicant: Tamara Orr, Belleville (CA)

(72) Inventor: Tamara Orr, Belleville (CA)

(21) Appl. No.: 15/602,155

(22) Filed: May 23, 2017

(51) Int. Cl. A41D 13/005; A41D 27/20; A41D 27/28; A41B 1/08; A41D 1/06; H05B 3/54

(52) U.S. Cl. CPC A41D 13/0051; A41D 27/205; A41D 27/285; A41B 1/08; H05B 2203/036; H05B 3/54; A41D 2300/32; A41B 2300/322; A41D 1/06

(57) ABSTRACT

A garment or body covering for heating selected portions of a wearer's body comprises a garment body, and pairs of arm and leg sleeves. The garment body has front, back, neck, right and left upper arm and thigh portions, a neck opening, right and left arm and leg openings and a center back zipper. The garment is made of fabric comprising interior and exterior neoprene layers having an intermediate layer therebetween. A plurality of heating elements, positioned in the intermediate layer, is in thermal communication with the garment body and arm and leg sleeves. The heating elements are powered by a plurality of batteries electrically coupled thereto. A plurality of control units operationally coupled to the batteries is configured to selectively turn on or off associated heating elements. A plurality of exterior pockets holds associated batteries and control units. The garment may alternatively be a shirt or pair of shorts.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to body coverings and more particularly pertains to a new garment or body covering configured to heat selected portions of a wearer's body.

### BRIEF SUMMARY OF THE INVENTION

An embodiment of the disclosure meets the needs presented above by generally comprising a garment or body covering configured to heat selected portions of a wearer's body. The body covering comprises a garment body, a pair of arm sleeves and a pair of leg sleeves configured to be worn on the wearer's body. The garment body is configured to be worn on the wearer's body and has a front portion, a back portion, a neck portion, a neck opening, a right upper arm portion, a right arm opening, a left upper arm portion, a left arm opening, a right thigh portion, and a left thigh portion. The pair of arm sleeves is configured for positioning on lower arms of the wearer. The pair of leg sleeves is configured for positioning on lower leg areas of the wearer. The garment body, the pair of arm sleeves and the pair of leg sleeves are made of a garment fabric comprising an interior layer of neoprene, an exterior layer of neoprene, and an intermediate layer 24 sandwiched between the interior and exterior layers of neoprene. The garment body has a center back opening with a zipper.

A plurality of heating elements are in thermal communication with the garment body, the pair of arm sleeves and the pair of legs, the heating elements positioned in the intermediate layer. The heating elements are positioned in the front portion, the back portion, the neck portion, the right and left upper arm portions and the right and left thigh portions of the garment body, and in the pair of arm sleeves and the pair of leg sleeves. A plurality of batteries is electrically coupled to the plurality of heating elements such that each of the heating elements is powered by at least one of the batteries. A plurality of control units are operationally coupled to the plurality of batteries and are configured to selectively turn on or off an associated heating element. A plurality of pockets located on the exterior layer hold associated batteries and control units, an associated one of said pockets, batteries, control units and heating elements defining a set such that a plurality of sets is defined. The body covering includes a plurality of sections, each section being separate from each other, each section including an associated one of the sets, the sections including a torso section including the front portion, back portion, right upper arm portion, left upper arm portion, right thigh portion, and left thigh portion, the pair of arm sleeves, and the pair of leg sleeves.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a body covering according to an embodiment of the disclosure.

FIG. 2 is a side view of an embodiment of the disclosure.

FIG. 3 is a back view of an embodiment of the disclosure.

FIG. 4 is a cross-sectional view along line 4-4 of FIG. 1.

FIG. 5 is a perspective view of an embodiment of the disclosure.

FIG. 6 is a front view of an embodiment of the disclosure in use.

FIG. 7 is a perspective view of an embodiment of the disclosure.

### DETAILED DESCRIPTION OF THE INVENTION

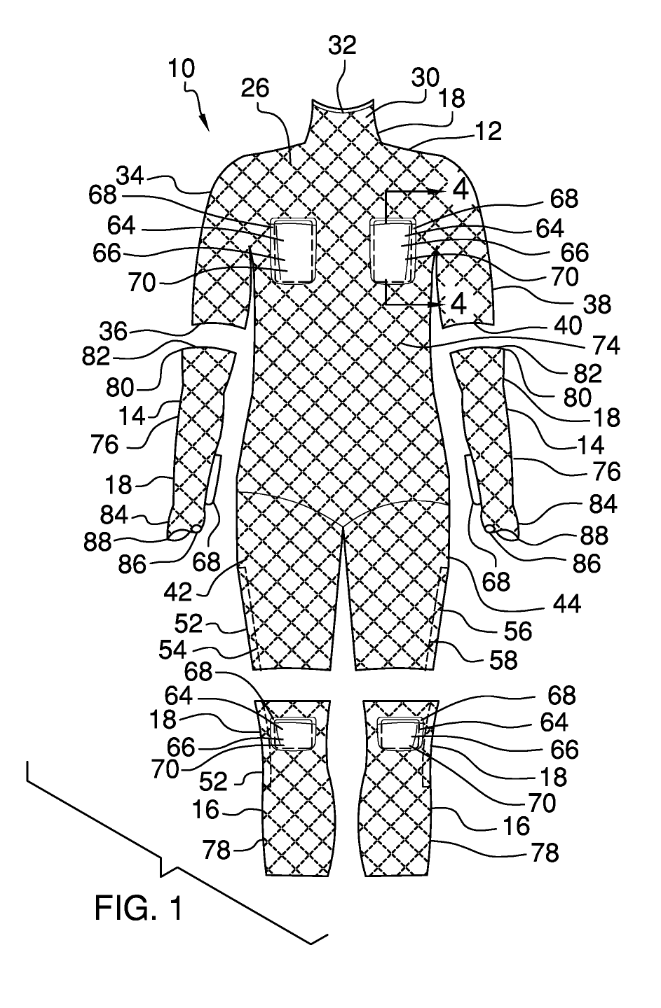

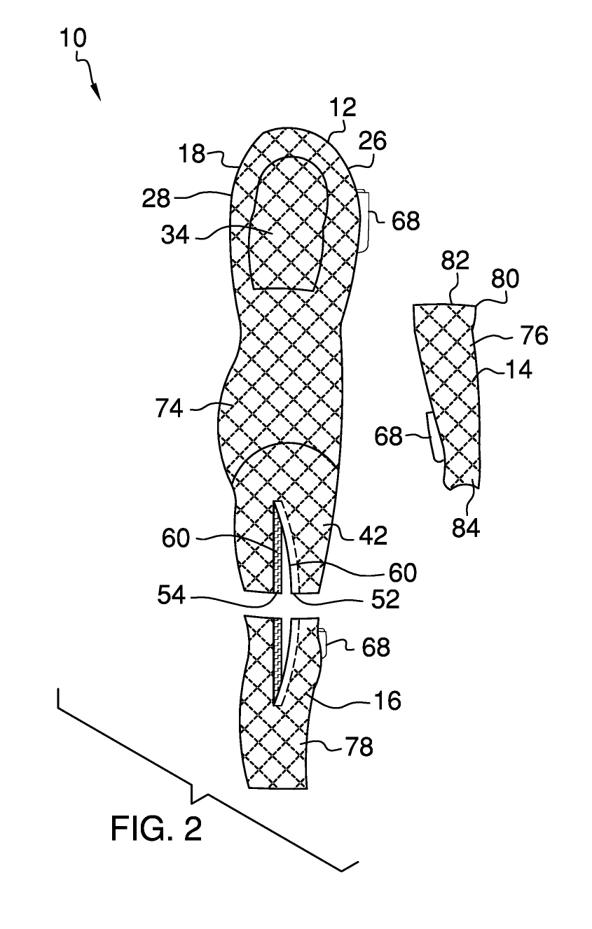

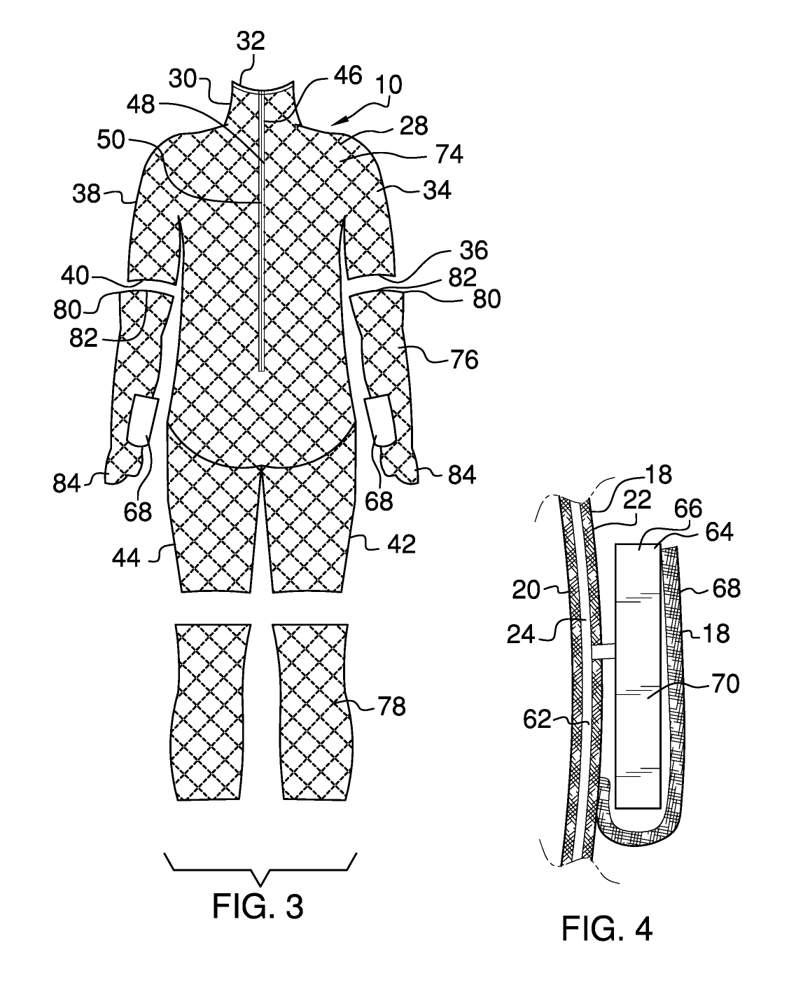

With reference now to the drawings, and in particular to FIGS. 1 through 7 thereof, a new body covering embodying the principles and concepts of an embodiment of the disclosure and generally designated by the reference numeral 10 will be described.

As best illustrated in FIGS. 1 through 7, the body covering 10 configured to heat selected portions of a body of a wearer, generally comprises a garment body 12, a pair of arm sleeves 14 and a pair of leg sleeves 16.

The garment body 12, the pair of arm sleeves 14 and the pair of leg sleeves 16 are made of a garment neoprene fabric 18, best shown at FIG. 4, comprising an interior layer of neoprene 20, an exterior layer of neoprene 22, and an intermediate layer 24 sandwiched between the interior layer of neoprene 20 and the exterior layer of neoprene 22.

The garment body 12 is configured to be worn on the body of the wearer and comprises a front portion 26, a back portion 28, a neck portion 30, a neck opening 32, a right upper arm portion 34, a right arm opening 36, a left upper arm portion 38, a left arm opening 40, a right thigh portion 42, and a left thigh portion 44. The pair of arm sleeves 14 is configured for positioning on lower arms of the wearer of the garment. The pair of leg sleeves 16 is configured for positioning on lower leg areas of the wearer of the garment.

In one embodiment according to the disclosure, the garment body 12 has a center back opening 46 located at the back portion 28 of the garment body 12, and a closure 48 positioned on the back portion 28 and releasably closing the center back opening 46, the closure 48 comprising a zipper 50.

In one embodiment of the disclosure, the garment body 12 includes a right medial thigh vent 52 located at the right thigh portion 42 of the garment body 12. A right thigh vent closure 54 is mounted on the right thigh portion 42 for closing the right medial thigh vent 52. A left medial thigh vent 56 is located at the left thigh portion 44 of the garment body 12, and a left thigh vent closure 58 is mounted on the left thigh portion 44 for closing the left medial thigh vent 56. Each of the right and left thigh vent closures 54, 58 includes a hook and loop fastener 60.

A plurality of heating elements 62 are in thermal communication with the garment body 12, the pair of arm sleeves 14 and the pair of leg sleeves 16, the heating elements 62 positioned in the intermediate layer 24. The heating elements 62 are positioned in the front portion 26, the back portion 28, the neck portion 30, the right and left upper arm portions 34, 38 and the right and left thigh portions 42, 44 of the garment body 12, and in the pair of arm sleeves 14 and the pair of leg sleeves 16. A plurality of batteries 64 are electrically coupled to the plurality of heating elements 62 such that each of the heating elements 62 is powered by at least one of the batteries 64. The batteries may be rechargeable, and may each include a connector for coupling the batteries to a battery charger. A plurality of control units 66 are operationally coupled to the plurality of batteries 64 and are configured to selectively turn on or off an associated heating element 62. A plurality of pockets 68 located on the exterior layer 22 hold associated batteries 64 and control units 66, an associated one of said pockets 68, batteries 64, control units 66 and heating elements 62 defining a set 70 such that a plurality of sets 70 is defined. The body covering 10 includes a plurality of sections, each section being separate from each other, each section including an associated one of the sets 70, the sections including a torso section 74 including the front portion 26, back portion 28, right upper arm portion 34, left upper arm portion 38, right thigh portion 42, and left thigh portion 44, an arm section 76 comprising the pair of arm sleeves 14, and a leg section 78 comprising the pair of leg sleeves 16.

In one embodiment according to the disclosure, as shown at FIGS. 1-3, the pair of leg sleeves 16 is configured for positioning on a knee and a calf of the lower leg areas of the wearer and may include a hook and loop closure 60. In a further embodiment as shown at FIG. 7, the pair of leg sleeves 16 is configured for positioning over a knee of the lower leg areas of the wearer.

In one embodiment of the disclosure, as shown at FIGS. 1-3, the pair of arm sleeves 14 are configured for positioning on an elbow and a forearm of the lower arm areas of the wearer. The arm sleeves 14 may include a first end 80 with a first opening 82, and a second end 84 with two openings, a thumb opening 86 and finger opening 88.

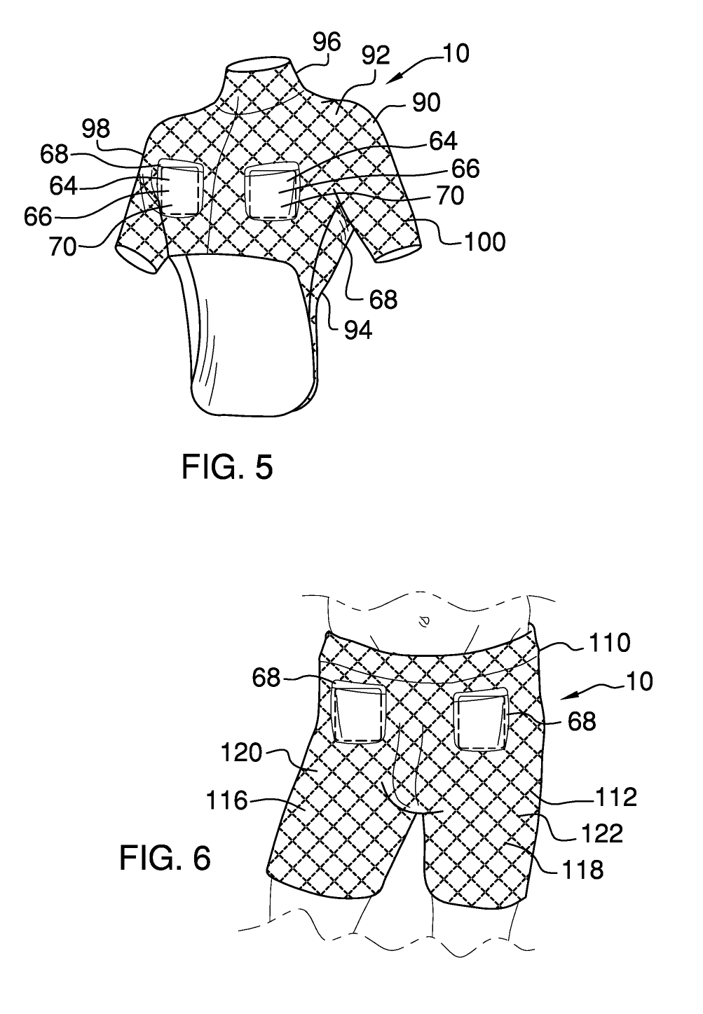

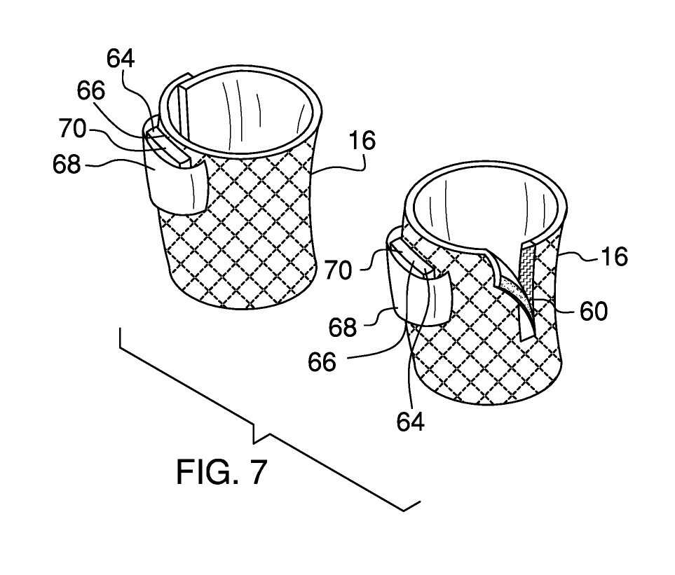

Referring to FIGS. 5-6, alternative embodiments of the body covering 10 are shown, which include like elements to those described with reference to FIGS. 1-4 and 7 which are numbered with the same number.

Referring to FIG. 5, an alternative embodiment of the body covering is shown, which comprises a shirt 90 which includes a front shirt portion 92, a back shirt portion 94, a shirt neck portion 96, a right upper arm shirt portion 98, and a left upper arm shirt portion 100. The shirt has a center front opening 102. In one embodiment, the center front opening is closed by a zipper 104, a non-limiting example of which is a lightweight invisible zipper. The shirt 90 includes a plurality of battery operated heating elements 62 in thermal communication with the front shirt portion 92, the back shirt portion 94, the shirt neck portion 96, and the right and left upper arm shirt portions 98, 100, the heating elements 62 being positioned in the intermediate layer 24 of the fabric 18. A plurality of batteries 64 are electrically coupled to the plurality of heating elements 62 such that each of the heating elements 62 is powered by at least one of the batteries 64. The batteries may be rechargeable, and may each include a connector for coupling the batteries to a battery charger. A plurality of control units 66 are operationally coupled to the plurality of batteries 64 and are configured to selectively turn on or off an associated heating element 62. A plurality of pockets 68 located on the exterior layer 22 of the fabric 18 hold associated batteries 64 and control units 66, an associated one of said pockets 68, batteries 64, control units 66 and heating elements 62 defining a set 70 such that a plurality of sets 70 is defined. The shirt 90 includes a plurality of sections, each section being separate from each other, each section including an associated one of the sets 70, the sections including a right front shirt section 106 and left front shirt section 108.

Referring to FIG. 6, an alternative embodiment, a pair of shorts 110 is shown, the shorts having a front shorts portion 112, a back shorts portion 114, a right shorts leg 116 and a left shorts leg 118. The pair of shorts 106 includes a plurality of battery operated heating elements 62 in thermal communication with the front shorts portion 112, the back shorts portion 114, and the right and left shorts legs 116, 118. The plurality of heating elements 62 are positioned in the intermediate layer 24 of the fabric 18. A plurality of batteries 64 are electrically coupled to the plurality of heating elements 62 such that each of the heating elements 62 is powered by at least one of the batteries 64. The batteries may be rechargeable, and may each include a connector for coupling the batteries to a battery charger. A plurality of control units 66 are operationally coupled to the plurality of batteries 64 and are configured to selectively turn on or off an associated heating element 62. A plurality of pockets 68 located on the exterior layer 22 of the fabric 18 hold associated batteries 64 and control units 66, an associated one of said pockets 68, batteries 64, control units 66 and heating elements 62 defining a set 70 such that a plurality of sets 70 is defined. The pair of shorts 110 includes a plurality of sections, each section being separate from each other, each section including an associated one of the sets 70, the sections including a right front shorts section 120 and left front shorts section 122.

In use, the wearer of a body covering according to the disclosure may use the control units 66 to selectively turn on and off the heating elements 62. In an alternative embodiment in accordance with the disclosure, each control unit may include a timer, and the wearer may use the control units 66 to turn on the heating elements 62, which may operate to provide heat for a predetermined length of time before automatically shutting off. In one non-limiting example, the heating elements are programmed to operate for 30 minutes before automatically shutting off.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A body covering configured to heat selected portions of a body of a wearer, said body covering comprising:
a garment body, a pair of arm sleeves and a pair of leg sleeves, said garment body configured to be worn on said body of said wearer and comprising a front portion, a back portion, a neck portion, a neck opening, a right upper arm portion, a right arm opening, a left upper arm portion, a left arm opening, a right thigh portion, and a left thigh portion, said pair of arm sleeves configured for positioning on lower arms of said wearer of said garment, said pair of leg sleeves configured for positioning on lower leg areas of said wearer of said garment, said garment body, said pair of arm sleeves and said pair of legs being made of a garment fabric comprising an interior layer of neoprene, an exterior layer of neoprene, and an intermediate layer sandwiched between said interior layer of neoprene and said exterior layer of neoprene;
a center back opening located at said back portion of said garment body;
a closure positioned on said back portion and releasably closing said center back opening;
a plurality of heating elements being in thermal communication with said garment body, said pair of arm sleeves and said pair of legs, said heating elements being positioned in said intermediate layer, said heating elements being positioned in said front portion, said back portion, said neck portion, said right and left upper arm portions and said right and left thigh portions of said garment body, and in said pair of arm sleeves and said pair of leg sleeves;
a plurality of batteries, each of said batteries being electrically coupled to one of said heating elements such that each of said heating elements is powered by at least one of said batteries. a plurality of batteries, each of said batteries being electrically coupled to one said heating elements such that each of said heating elements is powered by at least one of said batteries;
a plurality of control units, each of said control units being operationally coupled to one of said batteries and being configured to selectively turn on or off an associated one of said heating elements;
a plurality of pockets being located on said exterior layer, associated ones of said batteries and said control units being held in said one of said pockets;
wherein an associated one of said pockets, batteries, control units and heating elements define a set such that a plurality of sets is defined.

2. The body covering of claim 1, further comprising:
said body covering including a plurality of sections, each of said sections being separate from each other, each of said sections including an associated one of said sets, said sections including:
a torso section including said front portion, said a back portion, said right upper arm portion, said left upper arm portion, said right thigh portion, and said left thigh portion;
an arm section comprising said pair of arm sleeves; and
a leg section comprising said pair of leg sleeves.

3. The body covering of claim 1, further comprising:
a right medial thigh vent located at said right thigh portion of said garment body, a right thigh vent closure being mounted on said right thigh portion for closing said right medial thigh vent, a left medial thigh vent located at said left thigh portion of said garment body, and a left thigh vent closure being mounted on said right portion for closing said right medial thigh vent, each of said left and right thigh vent closures comprising a hook and loop fastener.

4. The body covering of claim 1, wherein said pair of leg sleeves is configured for positioning on a knee and a calf of said lower leg areas of said wearer.

5. The body covering of claim 1, wherein said pair of arm sleeves is configured for positioning on an elbow and a forearm of said lower arm areas of said wearer.

6. The body covering of claim 5, wherein said pair of arm sleeves comprises a right arm sleeve and a left arm sleeve, each of said right and left arm sleeves comprising a first end, a first opening at said first end, a second end, a thumb opening at said second end and a finger opening at said second end.

7. The body covering of claim 2, further comprising:
a right medial thigh vent located at said right thigh portion of said garment body, a right thigh vent closure being mounted on said right thigh portion for closing said right medial thigh vent, a left medial thigh vent located at said left thigh portion of said garment body, and a left thigh vent closure being mounted on said right portion for closing said right medial thigh vent, each of said left and right thigh vent closures comprising a hook and loop fastener.

8. The body covering of claim 7, wherein said pair of leg sleeves is configured for positioning on a knee and a calf of said lower leg areas of said wearer.

9. The body covering of claim 8, wherein said pair of arm sleeves is configured for positioning on an elbow and a forearm of said lower arm areas of said wearer.

10. The body covering of claim 9, wherein said pair of arm sleeves comprises a right arm sleeve and a left arm sleeve, each of said right and left arm sleeves comprising a first end, a first opening at said first end, a second end, a thumb opening at said second end and a finger opening at said second end.

11. A body covering configured to heat selected portions of a body of a wearer, said body covering comprising:
a shirt configured to be worn on said body of said wearer and comprising a front shirt portion, a back shirt portion, a shirt neck portion, a neck opening, a right upper arm shirt portion, and a left upper arm shirt portion, the shirt being made of a fabric comprising an interior layer of neoprene, an exterior layer of neoprene, and an intermediate layer sandwiched between said interior layer of neoprene and said exterior layer of neoprene;
a center front shirt opening located at said front shirt portion;
a front shirt closure positioned on said front portion and releasably closing said center front shirt opening, the front shirt closure comprising a zipper;
a plurality of heating elements being in thermal communication with said shirt, said heating elements being positioned in said intermediate layer, said heating elements being positioned in said front shirt portion, said back shirt portion, said shirt neck portion, and said right and left arm shirt portions;
a plurality of batteries, each of said batteries being electrically coupled to one of said heating elements such that each of said heating elements is powered by at least one of said batteries;
a plurality of control units, each of said control units being operationally coupled to one of said batteries and being configured to selectively turn on or off an associated one of said heating elements;
a plurality of pockets being located on said exterior layer, associated ones of said batteries and said control units being held in said one of said pockets;
wherein an associated one of said pockets, batteries, control units and heating elements define a set such that a plurality of sets is defined; and
said body covering including a plurality of sections, each of said sections being separate from each other, each of said sections including an associated one of said sets, said sections including a right front shirt section and a left front shirt section.

12. A body covering configured to heat selected portions of a body of a wearer, said body covering comprising:
a pair of shorts configured to be worn on said body of said wearer and comprising a front shorts portion, a back shorts portion, a right shorts leg and a left shorts leg, said pair of shorts being made of a garment fabric comprising an interior layer of neoprene, an exterior layer of neoprene, and an intermediate layer sandwiched between said interior layer of neoprene and said exterior layer of neoprene;
a plurality of heating elements being in thermal communication with said garment body, said pair of arm sleeves and said pair of legs, said heating elements being positioned in said intermediate layer, said heating elements being positioned in said front portion, said back portion, said neck portion, said right and left upper arm portions and said right and left thigh portions of said garment body, and in said pair of arm sleeves and said pair of legs;
a plurality of batteries, each of said batteries being electrically coupled to one of said heating elements such that each of said heating elements is powered by at least one of said batteries;
a plurality of control units, each of said control units being operationally coupled to one of said batteries and being configured to selectively turn on or off an associated one of said heating elements;
a plurality of pockets being located on said exterior layer, associated ones of said batteries and said control units being held in said one of said pockets;
wherein an associated one of said pockets, batteries, control units and heating elements define a set such that a plurality of sets is defined; and
said body covering including a plurality of sections, each of said sections being separate from each other, each of said sections including an associated one of said sets, said sections including a front right shorts section and a left front left shorts section.
